(19) United States
(12) Patent Application Publication
(10) Pub. No.: US 2006/0073256 A1
(43) Pub. Date: Apr. 6, 2006

(54) Self-foaming liquid creamers and processes

(76) Inventors: Frederic Destaillats, Belmont sur Lausanne (CH); Jean-Baptiste Bezelgues, Epalinges (CH); Pierre-Alain Golay, Lutry (CH); Olivier Schafer, Epalinges (CH); Martin Beaulieu, Rimouski (CA)

Correspondence Address: WINSTON & STRAWN LLP, 1700 K STREET, N.W., WASHINGTON, DC, 20006, US

(21) Appl. No.: 11/151,515

(22) Filed: Jun. 14, 2005

Related U.S. Application Data
(60) Provisional application No. 60/579,267, filed on Jun. 15, 2004.

(51) Int. Cl. A23J 3/00

(52) U.S. Cl. 426/570

(57) ABSTRACT

Self-foaming, liquid creamers including a first liquid component including an edible acid component, and a second liquid component comprising an edible salt, each liquid being shelf-stable and being operatively associated so that when the first and second liquids are combined carbon dioxide evolves to assist in providing the foam so that, when the liquid creamer is combined with the beverage, a portion of the creamer melts or disperses in less than about 20 seconds in the beverage to impart a creaming flavor and whitening color to the beverage with the remainder of the creamer forming a foam having a density that is less than that of the beverage so as to reside on top of the beverage as a visible foam layer, and methods of making foamed beverages therewith. The amount of foam generated in the beverage is dependent on the overrun of the foaming liquid creamer.

### CROSS-REFERENCE TO RELATED APPLICATION

This application claims the benefit of U.S. Provisional Patent Application No. 60/579,267, filed Jun. 15, 2004, the entire contents of which is incorporated herein by express reference thereto.

### FIELD OF THE INVENTION

The invention relates to natural-like self-foaming liquid creamers, and methods of making and using the same. More particularly, it relates to self-foaming liquid creamers that include a first liquid that includes an edible acid component and a second liquid that includes an edible salt, and methods.

### BACKGROUND OF THE INVENTION

A variety of methods are known for producing a foam layer on top of beverages, such as coffee. A primary example is the standard cappuccino coffee. Cappuccino-style coffees have a lower layer made of a coffee beverage and an upper layer of steamed frothy milk or cream. The coffee layer is made first and put into the beverage container and then the milk or cream is steamed and aerated to produce a froth or foam which is poured on the coffee layer. Other specialty coffee drinks are made similarly. Such methods of producing coffee drinks are usually encountered in restaurant or coffee shops and require specialized equipment. Furthermore, preparation of such drinks requires a skilled operator and is time consuming.

Thus, many products, such as foaming creamers and foaming beverages have emerged in the marketplace to fill the need of the coffee drinker. With the increased popularity of coffeehouses and coffee, even more foaming and creamer products have been introduced. Some of them are detailed below.

Conventional dry mix instant hot cappuccino compositions include a coffee component, a foaming creamer component, an optional sweetener component, together with other optional compositions such as flavor, color, and foam stabilizer components. The compositions are typically provided as a particulate powder or granulate composition in a hot liquid, such as water or milk. Sweetener, if not present in the composition, is normally added when the beverage is prepared. Hot cappuccino beverages have a substantial and characteristic foam on the top surface of the beverage usually provided by steamed milk in brewed cappuccinos and by particulate dry mix foaming creamers in instant cappuccinos.

Foaming beverages are popular because the whole beverage, complete with foam, is prepared in a single step, such as in instant cappuccino-style coffees. Such beverages are described in U.S. Pat. No. 5,882,716, U.S. Pat. No. 6,048,567, U.S. Pat. No. 6,174,557, U.S. Pat. No. 6,290,997, U.S. Pat. No. 6,569,486, U.S. Publication No. 2003/0157235, U.S. Publication No. 2003/0219522, International Publication No. WO 00/56163, and JP Publication No. 2003-000210. These pre-formed foaming beverages, however, do not allow the consumer the flexibility of tailoring the beverage according to personal preferences, such as the type of coffee or other beverage used. In addition, many coffee drinkers prefer fresh brewed coffees over instant coffee or coffee from concentrate.

U.S. Pat. No. 5,350,591 discloses a foaming creamer composition, in the form of a dry powdered mixture that contains components for generating carbon dioxide. EP 0,796,562 discloses a particulate dry mix foaming creamer that does not require incorporation of a gas for creating cappuccino foam. The foam is instead obtained by mixing gluconolactone and an alkali metal carbonate or bicarbonate. This foaming creamer can be used with dry mix soluble coffee produce or liquid beverages such as brewed coffee. It is said that all additives other than gluconolactones either cause formation of floating aggregates or suffer from incomplete solubility with resultant precipitation, saltiness, or other apparent flavor or texture changes, insufficient acidity to drive reaction with bicarbonate to generate adequate foam, or insufficient acidity to maintain original beverage pH.

Other dry creamer formulations that include a foaming agent are also widespread. Powdered or dry creamer formulations are described in U.S. Pat. No. 4,438,147, U.S. Pat. No. 5,462,759, U.S. Pat. No. 5,721,003, U.S. Pat. No. 5,780,092, U.S. Pat. No. 6,129,943, U.S. Pat. No. 6,168,819, U.S. Pat. No. 6,589,586, U.S. Publication No. 2002/0018839, U.S. Publication No. 2002/0127322, International Publication No. WO 97/25882, International Publication No. WO 03/041506, EP 0813815, EP 0885566, and JP Publication No. 08-038048. Problems associated with dry formulations include the disruption of the physical integrity or structure of the dry product that occurs during normal shipping and handling, such as when moisture contacts the dry powder. Such structural disruption often leads to less than desirable foaming properties and less than appealing sensory characteristics that detract from the freshness and appeal of the beverage.

Thus, some other types of creamers have been formulated. For example, U.S. Pat. No. 6,713,114 discloses a frozen beverage topping composition which results in a frothy or foam layer over a beverage. The beverage topping composition provides creaming and can flavor, sweeten, and slightly cool coffee and other beverages. The addition of the beverage itself produces the foam. Also, U.S. Publication No. 2004/0062846 discloses powdered and liquid, dairy and non-dairy creamer compositions. These creamer compositions can be prepared in both concentrated and ready-to-use forms, and may optionally include foaming agents.

Frequently, many of the foaming creamers in the prior art produce a brown or speckled colored foam, instead of a white foam. A brown foam detracts from the coffee-drinking experience. On the other hand, a white foam enhances the experience by allowing the drinker to feel like the beverage was produced with fresh ingredients, and perhaps in a traditional coffeehouse in the traditional way, i.e., with an espresso machine. Also, known foaming creamers can produce foam in hot beverages but none are known for use in cold beverages. Thus, there remains a need for a fresh and naturally foaming liquid creamer that provides a white foam when added to a liquid beverage of any temperature and that additionally provides a whitening color and creamer flavor to the beverage.

### SUMMARY OF THE INVENTION

The invention encompasses self-foaming, liquid creamers including a first liquid component comprising an edible acid component, and a second liquid component comprising an edible carbonate salt, bicarbonate salt, or combination thereof, with the first and second liquids being shelf-stable and being operatively associated so that when the first and second liquids are combined carbon dioxide evolves to assist in providing the foam so that, when the liquid creamer is combined with the beverage, a portion of the creamer melts or disperses in less than about 20 seconds in the beverage to impart a creaming flavor and whitening color to the beverage with the remainder of the creamer forming a foam having a density that is less than that of the beverage so as to reside on top of the beverage as a visible foam layer. In a preferred embodiment, the first and second components are shelf-stable and physically separated.

In one embodiment, at least one of the first or second liquids further includes a protein solution or a polysaccharide solution, or both. The protein solution preferably includes a milk powder, whey protein isolate, sweet whey powder, acid whey powder, or calcium caseinate, or a combination thereof. The polysaccharide solution preferably includes maltodextrin.

Typically, the first and second liquids each have a total solids content of 0.001% to about 50%. In a preferred embodiment, the first liquid includes a maltodextrin solution with a total solids content of 1% to about 40%. In another preferred embodiment, the second liquid includes an aqueous skim milk powder solution with a total solid content of about 1% to 60% or includes a protein solution made basic with about 0.5% to 10% of carbonate or bicarbonate salt, or a combination thereof, with a total solid content of about 1% to 40%.

The acid component may be an organic acid, inorganic acid, or a combination thereof. The acid component may be, for example, citric acid, ascorbic acid, tartaric acid, fumaric acid, alginic acid, malic acid, succinic acid, lactic acid, gum arabic, low-methoxy pectin, high-methoxy pectin, glucono-delta-lactone, polygalacturonic acid, monocalcium phosphate monohydrate, monocalcium phosphate, sodium phosphate, potassium phosphate, or combinations thereof. In a preferred embodiment, the acid component includes ascorbic acid.

The carbonate and bicarbonate salts used include sodium carbonate, sodium bicarbonate, potassium carbonate, potassium bicarbonate, ammonium bicarbonate, magnesium bicarbonate, calcium carbonate, or a combination thereof. In addition, the creamer may be in the form of either a dairy or a non-dairy creamer. In a preferred embodiment, the bicarbonate salt is potassium bicarbonate.

Advantageously, the creamer may be disposed in a variety of ways. In one embodiment, the first and second components are disposed in separate compartments of a single package. In another embodiment, the first and second liquids are enclosed in one compartment of a single package. When only one compartment contains the two liquids, at least one of the acid component and the salt are preferably encapsulated with a fat-based coating having a melting point of at least about 25° C. The coating may include one or more monoglycerides, diglycerides, triglycerides, acetic acid esters of mono or diglycerides, lactic acid esters of mono or diglycerides, sodium stearoyl lactylates, diacetyl tartaric acid esters of mono or diglycerides, sucrose esters, lecithin, or propylene glycol esters of fatty acids, waxes, fatty alcohols, or combinations thereof.

In a preferred embodiment, the beverage includes tea, coffee, or chocolate, or a combination thereof. In another preferred embodiment, the invention relates to non-pressurized containers including the self-foaming creamer. Yet another aspect of the invention relates to a vending machine that includes and dispenses a plurality of products at least one of which includes the above-noted creamer.

The invention also relates to a method for providing a foamed, whitened beverage product by combining the first and second liquid components of the creamer of the invention to generate a sufficient amount of carbon dioxide to facilitate formation of foam to the creamer, and combining a sufficient amount of the creamer with beverage components to provide a foamed, whitened beverage having a foam layer thereon and a creaming effect therein.

The invention further relates to methods for providing a whitened beverage product having a perceived fresh upper foam layer by combining with a water-containing beverage a liquid creamer that provides a foam in the beverage and disperses throughout the beverage to whiten the beverage after being combined therewith, and allowing the foam to rise to form an upper foam layer on the beverage. In a preferred embodiment, the first and second components of the liquid creamer self-foam the creamer before combination with the beverage to provide the foamed beverage. In yet another preferred embodiment, the creamer disperses throughout the beverage in less than about 20 seconds.

The invention encompasses a ready-to-use self-foaming liquid creamer including first and second liquid components such that a portion of the creamer provides a foam layer and, when combined with a water-containing beverage, the remainder of the creamer partly melts or disperses in less than about 20 seconds to provide a whitening color and creamer flavor to the beverage and the foam layer has a density of less than the beverage so as to reside upon the beverage. In one preferred embodiment of the ready-to-use creamer, the first component is a first liquid including an edible acid component and the second component is a second liquid including an edible carbonate salt, bicarbonate salt, or combination thereof, with the first and second liquids being refrigerator-stable and being operatively associated so that when the first and second liquids are combined carbon dioxide evolves to assist in providing the foam, and wherein, when the liquid creamer is combined with the beverage, a portion of the foam disperses in the beverage to impart a creaming and whitening effect to the beverage and the remainder of the foam resides on top of the beverage as a visible foam layer.

The invention also relates to self-foaming liquid creamers including a first pre-creamer component that includes a first liquid comprising an edible acid component, and a second pre-creamer component that includes a second liquid comprising an edible carbonate salt, bicarbonate salt, or combination thereof, with the first and second liquids each being shelf-stable, physically separated, and being operatively associated so that, when the first and second liquids are combined, carbon dioxide evolves to assist in providing the foam, and wherein, when the liquid creamer is combined with the beverage, a portion of the foam partly melts or disperses in the beverage in less than about 20 seconds to impart a creaming and whitening effect to the beverage and the remainder of the foam resides on top of the beverage as a visible foam layer. In one preferred embodiment, at least one of the edible acid component and the edible salt component is encapsulated with a fat-based coating that has a melting point of at least about 25° C.

### BRIEF DESCRIPTION OF THE DRAWINGS

Further features and advantages of the invention can be ascertained from the following detailed description that is provided in connection with the drawing(s) described below:

FIG. 1 illustrates the foaming and whitening properties of a creamer according to the present invention, when added to a hot cappuccino coffee-beverage.

### DETAILED DESCRIPTION OF THE PREFERRED EMBODIMENTS

The present invention surprisingly and unexpectedly provides a self-foaming, natural-like liquid creamer that includes a white foaming layer and that whitens and provides a creamer flavor to a beverage, thereby enhancing the visual appeal, the flavor, and the texture of the beverage. The white foam provided by the creamer is preferably similar, both visually and in taste and smell, to the steamed and foamed milk traditionally placed on top of cappuccino-style beverages. The creamer, however, is ready-to-use and is readily dispersible in both hot and cold beverages to provide a whitening effect and creamer flavor, and produces a white foam without the use of complicated equipment or machinery. Beverages that may be used in combination with the creamer include, for example, coffee, tea, chocolate, liquor, soup, juice, and the like, or any combination thereof (e.g., tea and lemonade, or coffee and liquor). Preferred beverages include tea, coffee, or hot chocolate, or a combination thereof.

Accordingly, the present invention relates to a self-foaming, liquid creamer that includes a first and second component such that a portion of the creamer provides a foam layer and, when combined with a water-containing beverage, the remainder of the creamer partly melts or disperses in less than about 20 seconds to provide a whitening color and creamer flavor to the beverage. The creamers of the invention are preferably natural-like, i.e., approximate the texture and appearance of foamed natural products like milk or cream. Natural-like should also be understood to include a processed creamer that has an improved stability over natural products to increase convenience in preparing and storing such creamers compared to a conventional coffeehouse product such as steamed milk. The natural-like products of the invention will have a perceived organoleptic characteristic that is at least equivalent to such conventional coffeehouse products. The foam layer has a density of less than the beverage so as to reside upon the beverage. The density is preferably about 0.1 g/cm³ to 0.6 g/cm³, and more preferably, from of about 0.25 g/cm³ to 0.45 g/cm³.

In one simple step, a beverage drinker can combine a liquid creamer of the invention with a beverage to improve the flavor and texture of the beverage, modify the color of the beverage it is combined with, and at the same time, provides a foam or frothy layer of gas-entrapped within liquid on the top surface of the coffee. Preferably, no manual stirring is required to combine the beverage and liquid creamer. Providing a natural-like creamer in liquid form that functions similarly to the flavor, color, and texture benefits of a foamed natural milk enhances a consumer's perception of the beverage as both fresh and natural, and decreases the time a consumer must wait to enjoy the hot or cold beverage. The freshness can be achieved by using creamer components that do not tend to denature, i.e., the natural-like creamers of the invention can be substantially free or entirely free of proteins or other components that denature. Thus, even components from milk, cream, or other natural components can be included in forming the creamer of the invention. Advantageously, a consumer can turn a homemade cup of, e.g., coffee into a coffeehouse-style gourmet beverage, with a rich texture, whitening effect, and a visible foam layer. The amount of foam generated by the self-foaming creamer can be readily determined by those of ordinary skill in the art, particularly with reference to the description of the invention herein.

The creamer may be a dairy or non-dairy creamer. Thus, another surprising and unexpected advantage of the present invention is that a natural-like non-dairy creamer can be provided that approximates the whitening, foaming, and flavor of a fresh dairy creamer. This advantageously benefits those who prefer to minimize or avoid the intake of dairy products, e.g., lactose intolerant persons, or the like. Additionally, the liquid creamers of the present invention, whether dairy or non-dairy, have the desirable benefit of having a longer shelf-life compared to fresh milk or cream. The inventive creamers can be stored with or without refrigeration. Preferably, the components used do not require refrigeration, i.e., they are shelf-stable, and are formulated to be suitable for long-term, shelf storage without refrigeration, for example, for at least about 3 months, preferably at least about 6 months. The natural-like liquid creamers of the claimed invention can even include a portion of certain components of fresh milk if desired, or the creamers can be substantially or entirely free of the perishable components typically found in fresh milk to increase shelf-life while maintaining the foaming, whitening, and flavor enhancing benefits of a natural creamer.

The creamer of the invention can also be at least substantially fat-free, or preferably entirely fat-free, to provide the flavor, texture, and visual benefits of a real creamer without adding unhealthy fat content. Preferably, the creamer can also contain ascorbic acid and therefore it can be a source of water soluble vitamin. In self-foaming creamers, the ascorbic acid can surprisingly act both to provide a nutritional benefit and to provide the foam in combination with an edible carbonate salt, bicarbonate salt, or combination thereof.

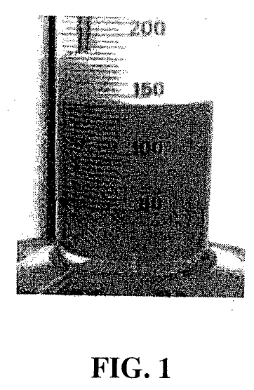

The creamer is a self-foaming, liquid creamer that typically includes a first liquid that includes an edible acid component and a second liquid that includes an edible salt. The two liquids should be at least substantially, preferably entirely, miscible with each other, and should be stable when acidified or alkalized. The edible salt typically includes a carbonate salt, bicarbonate salt, or a combination thereof. When the first and second liquids are combined, carbon dioxide evolves and a white foam is produced. When the liquid creamer is combined with, or generated in, a beverage, a portion of the foam disperses in the beverage to impart a creaming and whitening effect to the beverage, while the remainder of the foam resides on top of the beverage as a visible foam layer. The dispersing can occur as a result of any suitable chemical or physical process, and typically involves melting or dissolving of the foam portion into the liquid beverage. FIG. 1 illustrates both the foaming and whitening effects of the creamer when added to a hot cappuccino beverage.

The foam is typically formed instantaneously by mixing, for example, equivalent volumes of the first and second liquids. Although one of the first or second liquids may be present in a larger amount than the other, each must be present in an amount sufficient to generate enough foam to provide a visible foam layer and for a part of the foam to disperse within the beverage to provide the beneficial whitening effect and flavor enhancement to the beverage. The foam may be formed in a separate container, and then poured onto the beverage. Optionally, the foam may be generated by pouring the two liquids separately into the beverage or combining one liquid component with a beverage and then adding the second liquid component to form the foam in situ. In these optional embodiments where the foam is generated in situ, foam obtained will be of substantially the same color as the beverage. It should be understood for all embodiments of the invention that the liquid creamer may be provided to a drinking container first, followed by the beverage; by the beverage first and then the liquid creamer; by alternating portions of beverage and creamer; or any other suitable method for combining the beverage and creamer. The first and second liquids preferably have the capability to produce a large volume of white, fine, and preferably homogeneous foam after mixing. The large amount of carbon dioxide that is generated by the acid-base reaction allows for the aeration of the mixture that is formed. The acid-base reaction is represented chemically below:
HA+XHCO₃→XA+H₂O+CO₂
HA corresponds to the acid component in the first liquid and XHCO₃ corresponds to the basic salt in the second liquid. Combining the two liquids yields a salt, XA, water and carbon dioxide. For the best results, a sufficiently large volume of carbon dioxide should be released rapidly. This volume should be sufficiently large to evolve enough gas to foam a majority, preferably substantially all, and more preferably all, of the liquid creamer that is present.

In one embodiment, at least one of the first or second liquids further includes a protein solution or a polysaccharide solution, or both. The protein solution may be any solution of foamable or foaming proteins. The protein solution may include egg and milk proteins, plant proteins, microbial proteins, or mixtures thereof. The protein solution preferably includes a milk powder, whey protein isolate, sweet whey powder, acid whey powder, or calcium caseinate, or a combination thereof. The polysaccharide solution may include any suitable carbohydrate, and for example starches, celluloses, alginates, and the like. Preferably, the polysaccharide solution includes maltodextrin. Suitable amounts of protein solution, polysaccharide solution, sweetener, and flavorings can be included as desired or in amounts readily determined by those of ordinary skill in the art, particularly with reference to the description of the invention herein.

Optionally, one or both of the first and second liquids include one or more sweeteners and/or flavorings. The sweetener may be a non-caloric, low caloric, or caloric sweetener. Sweeteners impart a wide range of overall sweetness to the creamer. Non-caloric or low-caloric sweeteners generally include a high intensity sweetener and a bulking agent. Bulking agents can help maintain the overall structure and integrity of the creamer while imparting little or no sweetness. Caloric sweeteners generally include sugars or mixtures of sugars, such as fructose, sucrose, dextrose, maltose, lactose, high fructose corn syrup solids, invert sugar, sugar alcohols, and the like, as well as mixtures of these sweeteners. Flavorings are used to deliver one or more specific flavors to the beverage. These flavorings may be natural or artificial in origin. Preferred flavors include amaretto, almond nut, anisette, brandy, mint, chocolate, cinnamon, cinnamon almond, mocha, vanilla, toffee, cappuccino, lemon, macadamia nut, orange, peach, strawberry, grape, raspberry, cherry, coffee, and the like, and mixtures thereof. The addition of flavorings to the creamer can further enhance the coffee-drinking experience.

The first and second liquids typically each have a total solid content of 0.001% up to about 50%, preferably about 1% to 48%, more preferably about 20% to 40%. In one embodiment, the first liquid includes a whey protein solution (e.g., maltodextrin) with a total solid content of about 5% to 40% or a calcium caseinate solution with a total solid content of about 0.001% to 20%, or both. The first liquid is preferably acidified with an organic or inorganic acid component sufficient to acidify the creamer to promote formation of foam with a carbonate or bicarbonate salt. Thus, preferably, the first liquid is preferably acidified with an acid component to a pH of about 1 to 6, preferably 2 to 5. An exemplary acid component pH is about 2.5. In another embodiment, the second liquid includes an aqueous skim milk powder solution with a total solid content of about 1% to 60% or a protein solution made basic with about 0.5% to 10% of carbonate or bicarbonate salt, or a combination thereof, with a total solid content of about 1% to 40%. An acid component, such as citric acid, however, cannot be added to the second liquid without the precipitation of proteins. Thus, the acid component is preferably included in the first liquid with, for example, a whey protein solution to minimize or avoid precipitation of any components, which can undesirably affect the flavor and/or visual appearance of a beverage and creamer combination. Indeed, the creamer of the present invention is substantially free of or entirely free of, and when combined with a beverage will still be substantially free of or entirely free of, precipitates. Preferably, all components of the creamer, beverage, and combination thereof, will be substantially or entirely soluble.

The acid component may include one or more organic acids, inorganic acids, or a combination thereof. Organic acid salts and derivatives, such as anhydrides, esters or lactones may also be used. Examples of suitable organic acids or salts include citric acid, ascorbic acid, tartaric acid, fumaric acid, alginic acid, malic acid, succinic acid, gum arabic, low-methoxy pectin, high-methoxy pectin, glucono-delta-lactone, polygalacturonic acid, potassium bitartrate, monocalcium fumarate, monopotassium fumarate, monosodium citrate, disodium citrate, sodium alginate, and potassium alginate. Examples of suitable inorganic acids include monocalcium phosphate monohydrate, anhydrous monocalcium phosphate, sodium acid pyrophosphate, sodium aluminum phosphate, dicalcium phosphate dihydrate, potassium metaphosphate, monosodium phosphate, monopotassium phosphate, and sodium hexametaphosphate. Preferably, the acid component includes citric acid, ascorbic acid, tartaric acid, fumaric acid, alginic acid, malic acid, succinic acid, lactic acid, gum arabic, low-methoxy pectin, high-methoxy pectin, glucono-delta-lactone, polygalacturonic acid, monocalcium phosphate monohydrate, monocalcium phosphate, sodium phosphate, potassium phosphate, or combinations thereof.

The carbonate and bicarbonate salts include sodium carbonate, sodium bicarbonate, potassium carbonate, potassium bicarbonate, ammonium bicarbonate, magnesium bicarbonate, or calcium carbonate, or a combination thereof.

The acid-base reaction preferably produces a large volume of foam in a reasonable period of time, for example, less than about 20 seconds, preferably less than about 10 seconds, and more preferably less than about 5 seconds after mixing of the two liquids. In an exemplary embodiment, substantially all of the foam is formed immediately within three seconds after combining the first and second liquids. Preferably, the whitening and creaming effects of the creamer in every embodiment also occur in substantially the same time period. Preferably, the volume of foam produced is about 2 to 40 volume percent of the beverage, more preferably about 5 to 20 volume percent of the beverage. The acid-base reaction should not, however, excessively acidify the beverage, particularly to the extent that undesirable tastes are introduced into the beverage flavor as a result of the inventive foaming creamer.

In addition, combination of the first and second liquids for the production of carbon dioxide in the liquid creamer preferably will not produce off-flavors and/or a salty taste. Importantly, their combination preferably minimizes or avoids the formation of floating aggregates caused by, for example, protein coagulation or precipitation or formation of insoluble salts. The use of a stoichiometric mixture of tartaric or citric acids and a bicarbonate in a solution with dairy components will usually induce protein precipitation. Moreover, the use of pure inorganic salts can liberate free metallic cations, such as Ca²⁺, which can induce protein complexation, and the appearance of floating complexes. Thus, in one embodiment, the acid component is a binary mixture of monocalcium phosphate monohydrate and tartaric acid with a weight ratio of about 1.5:1 to 3:1, preferably about 2:1. The reaction of this binary acid mixture with a bicarbonate generally induces the formation of soluble complexes with gas formation.

Another preferred embodiment is where the acid component includes ascorbic acid, which tends to acidify the beverage to a lesser extent than tartaric or citric acid, thus minimizing or preventing protein precipitation. Furthermore, the complexes are stable and do not contribute to the formation of floating aggregates. Finally, ascorbic acid has good organoleptic properties in addition to providing a nutritional benefit.

Because the creamer self-foams, typically proximate in time to addition to a beverage or beverage components, the foaming creamer does not require a pressurized container, such as an aerosol can, to produce the foam. Consequently, the creamer can be packaged in less expensive and more environmentally-friendly containers, such as a non-pressurized container. Frequently, aerosol cans also include environmentally harmful chemicals, typically propellants, such as chlorofluorocarbons, that can damage the ozone layer. Use of a non-pressurized container aids in the preservation of the environment and its resources.

The invention also includes packaging or a container including a creamer of the invention. The creamers can be packaged for use, and each package can hold a sufficient amount of the first and second creamer components for a single serving, or for multiple servings, or even for bulk use or food service usage. The single-serve or multi-serve packages can optionally be packed into a multi-packaged cases or cartons for shipment and sale to supermarkets, convenience stores, or the like. The package may be in the form of compartmentalized can, carton, jar, bottle, cup, or any other conventional or disposable containers used to hold liquids. For example, the container can be a plastic bottle, and preferably, a multi-layer plastic bottle. Any suitable plastic or polymer material or a combination thereof may be used to form the plastic bottle. Examples include polyesters, polyvinyl chlorides, polyethylenes, and polypropylenes. Preferably, one or more polyolefinic materials is used. In one preferred embodiment, the package is a bottle that is rigid or squeezable. In one embodiment, the creamer can be part of a vending machine suitable for the delivery of dairy or non-dairy creamer.

The liquid creamers can be preferably packaged in a non-pressurized container, i.e., they do not require pressurization for shipping, storage, or the like. Non-pressurized typically means at or about ambient pressure, and preferably non-pressurized creamers are at least substantially or entirely free of propelling gas, e.g., nitrous oxide, as this is unnecessary for foam formation. This can surprisingly permit the use of conventional packaging for foamed creamer products of the invention as noted above. Preferably, the container can minimize or even avoid the need for special coatings, foil packaging, vacuum-packing, or other special freshness-preserving efforts, as a non-pressurized container will typically provide suitable refrigerator stability to the foamed creamer of the invention. Preferably, the packaging of the creamer is a non-pressurized bottle or can or box of any suitable food-grade material or a multi-layer material with the innermost layer being made of food-grade material. An exemplary package is a non-pressurized bottle. The creamer can be packaged so that the consumer can simply open the package and add the foamed creamer to the beverage. This embodiment can be suitable for placement and sale in vending machines.

In one embodiment, the first and second liquids of the creamer are disposed in separate compartments of a single package. A consumer would typically open the package and pour the liquid contents of the separate compartments into another container, such as a cup, to produce the foam. Thereafter, the consumer would pour the foam into a beverage. Alternatively, the package contents can be poured directly and at the same time, or sequentially, into a beverage or a container to form the foam in situ.

In another embodiment, the first and second components of the binary system are enclosed in one compartment of a single package. To prevent premature formation of the foam in the compartment, at least one of the acid component and the salt are preferably encapsulated with a fat-based coating having a melting point of at least about 25° C., preferably at least about 35° C. In one embodiment, this melting point can be at least about of at least about 45° C. The acid component and salt component are then dispersed in a liquid matrix having good foaming characteristics, such as a skim milk powder aqueous solution. At room temperature, the fat-based coating is solid and prevents the reaction of the acid component and salt. By adding a beverage, such as coffee, with a temperature higher than the melting temperature of the fat coating, the coating gradually melts over time, e.g., about 0.1 to 20 seconds, and causes the release of the acid component and/or salt, thereby causing them to react and generate the foam. The coating preferably includes one or more monoglycerides, diglycerides, triglycerides, acetic acid esters of mono or diglycerides, lactic acid esters of mono or diglycerides, sodium stearoyl lactylates, diacetyl tartaric acid esters of mono or diglycerides, sucrose esters, lecithin, or propylene glycol esters of fatty acids, waxes, fatty alcohols, or combinations thereof.

The creamer of the present invention is substantially free of, and preferably entirely free of, fat/oil microparticulates or emulsifiers, or both. Advantageously, the creamer does not require an emulsifier to readily disperse in the hot or cold beverage. Fats or oils, when used, are generally included in the creamer only as a coating for the acid and/or salt components.

This one compartment/single package embodiment is useful primarily only for creamers to be used with hot beverages. Preferably, the first and second liquids are combined in a way that avoids or minimizes use of fat-based coatings with melting points of at least about 25° C. so that the creamer can form foam rapidly even in cold beverages.

In one embodiment, the salt is ground to a suitable particle size, e.g., less than about 100 μm, preferably less than about 80 μm, and more preferably less than about 50 μm, and dispersed in the coating system. The coated salt is then spray chilled, and the resulting powder dispersed in the foamable mixture.

Additionally, while less preferred, the acid component and salt may initially react in the package to form a portion or all of the foam. This could be accomplished, for example, by coating only a portion of the acid component and/or salt. In this embodiment, the consumer would not have to wait as long for the acid-base reaction to occur before enjoying the foamed beverage. The consumer would simply open the package and add the foamed creamer to the beverage. This embodiment can be suitable for placement and sale in vending machines.

As used herein, “white” refers to the color of milk, cream, or the like, and can include beige or other off-white colors. The term “disperses” includes the possibilities that, e.g., the foam melts or dissolves, within the beverage.

The liquid components can be pasteurized or otherwise heat treated to enhance shelf-stability. The portion of the natural-like liquid creamer that imparts a creaming effect and whitens the beverage is preferably at least substantially dispersed, and more preferably entirely dispersed within the beverage. In a most preferred embodiment, the portion is uniformly dispersed within the beverage. Conventional whipped cream toppings generally do not disperse in beverages, e.g., throughout the beverage, and thus do not impart a whitening effect to the beverage. The creamer described herein, however, provides a foam that both disperses in beverages to impart a whitening effect and desirable flavor modification to the beverage, while modifying the texture of the beverage and creating a foam layer.

The shelf life of these liquid creamers, or components thereof, is at least about 60 days, preferably at least about 90 days, and more preferably at least about 120 days, or even longer at refrigerated temperatures. Refrigerated temperatures generally include those less than about 10° C., preferably less than about 6° C., while ambient temperature for shelf-stability is considered to be 20° C. The creamers of the invention are typically stored at temperatures greater than freezing (0° C.) to facilitate their presence in liquid form.

The invention may also include a set of instructions for preparing a beverage in a drinking container, which includes instructions (such as on a label, packaging, or an insert), to dispose a caffeinated beverage into a selected drinking container, and to prepare and dispose a liquid, self-foaming, natural-like creamer into the drinking container or beverage. Either order of disposing the beverage and creamer may be specified, and the creamer can be foamed in situ by adding the acid and salt components in either order directly into the beverage rather than first forming the foaming creamer and then combining it with the beverage. The disposing of the beverage or the natural-like creamer liquid, or components thereof, is preferably sufficient to disperse the creamer throughout the beverage without a spoon. The set of instructions may be displayed, for example, on the package for the creamer. In one embodiment, it is preferred that the beverage is at least about 100° C. to facilitate foaming and/or dispersion. Particularly when a fat or oil encapsulant is used around one or both the acid or salt components, a warmer beverage may be preferred to facilitate melting of the encapsulant and increase the generation timing and/or rate of foam. In another embodiment, a lower viscosity foamed creamer can be formulated to facilitate foaming and dispersion even in a cold beverage, e.g., one at ambient temperature or even chilled to refrigerator temperatures.

The invention also encompasses various delivery methods and equipment, such as vending machines, for delivering the self-foaming natural-like liquid creamers of the present invention. In one embodiment, the invention encompasses a vending machine that includes and dispenses a plurality of products at least one of which is the creamer previously described. Other products included in the vending apparatus can include any suitable beverage or components thereof.

### EXAMPLES

The following examples are not intended to limit the scope of the invention, but merely to illustrate representative possibilities concerning the present invention.

### Example 1

### Preparation of Hot Cappuccino Beverage According to the Invention

Hot cappuccino beverages were prepared by adding to about 120 mL of dark coffee, prepared from dehydrated Nescafe Gold instant coffee with the dairy foam being obtained by mixing 20 mL of liquid 1A and 20 mL of liquid 2. The compositions of the liquids are provided below. The foam formed by mixing liquids 1A and 2 was sweet. If liquid 1B was used instead of 1A, an unsweetened dairy foam was obtained. By mixing 20 mL of each liquid 1 and 2, about 100 to 130 mL of white and fine dairy foam of the invention were surprisingly and unexpectedly obtained. This foam had a density value of about 0.3-0.4 and had good whitening properties.

| | Liquid 1 | | |
|---|---|---|---|
| Components | A | B | Liquid 2A |
| Water | 68 | 88 | 77 |
| Skim milk powder | — | — | 20 |
| Maltodextrin DE 21 | 10 | 10 | — |
| Sucrose | 20 | — | — |
| Potassium bicarbonate | — | — | 3 |
| Tartaric acid | 0.66 | 0.66 | — |
| Monocalcium phosphate monohydrate | 1.33 | 1.33 | — |

### Example 2

### Preparation of Hot Cappuccino Beverage According to the Invention

Hot cappuccino beverages were prepared by adding to about 120 mL of dark coffee, prepared from dehydrated Nescafe Gold instant coffee with the dairy foam being obtained by mixing 20 mL of liquid 1C and 20 mL of liquid 2B. The compositions of the liquids are provided below. In this example, the acid used was ascorbic acid. By mixing 20 mL of each liquid 1C and 2B, about 100 to 130 mL of white, sweet and fine dairy foam of the invention were surprisingly and unexpectedly obtained. This foam had a density value of about 0.3-0.4 and had good whitening properties.

| | |
|---|---|
| Liquid 1 | Liquid 2 |

| Components | C | B | C |
|---|---|---|---|
| Water | 57 | 77 | |
| Whole milk | | | 87 |
| Skim milk powder | — | 20 | 10 |
| Maltodextrin DE 21 | 20 | — | |
| Sucrose | 20 | — | |
| Potassium bicarbonate | — | 3 | 3 |
| Ascorbic acid | 3 | — | |

### Example 3

### Preparation of Hot Cappuccino Beverage According to the Invention

Hot cappuccino beverages were prepared by adding to about 120 mL of dark coffee, prepared from dehydrated Nescafe Gold instant coffee with the dairy foam being obtained by mixing 20 mL of liquid 1C and 20 mL of liquid 2C. The compositions of the liquids are provided above. In this example, the dairy liquid used contain whole milk. By mixing 20 mL of each liquid 1C and 2C, about 100 to 130 mL of white, sweet and fine dairy foam of the invention were surprisingly and unexpectedly obtained. This foam had a density value of about 0.3-0.4 and had good whitening properties.

### Example 4

### Preparation of Iced Cappuccino Beverage According to the Invention

Iced Cappuccino beverages were prepared by adding to about 120 mL of iced coffee with the dairy foam being obtained by mixing 20 mL of liquid 1C and 20 mL of liquid 2B (vide supra). In this example, the acid used was ascorbic acid. By mixing 20 mL of each liquid 1C and 2B, about 100 to 130 mL of white, sweet and fine dairy foam of the invention were surprisingly and unexpectedly obtained. This foam had a density value of about 0.3-0.4 and had good whitening properties.

### Example 5

### Preparation of Self-Foaming Liquid Creamer According to the Invention

A mixture containing 40 mL of a skim milk powder solution with a pH of about 6.7 and a total solid content of about 40% was combined with about 600 mg of dispersed fat-coated salts. The coated salts included about 300 mg of potassium bicarbonate (CAS 298-14-6), about 100 mg of tartaric acid (CAS 87-69-4), and about 200 mg of monocalcium phosphate monohydrate (CAS 7758-23-8). The fat-based coating was 600 mg of a triglyceride product under the tradename Witocan 42/44 commercially available from Sasol North America of Houston, Tex., and 6 mg of Grindsted PGMS SPV, a propylene glycol ester commercially available from Danisco, DK-8280 Brabrand, Denmark.

### Example 6

### Preparation of Hot Cappuccino Beverage with a Non-dairy Self-foaming Liquid Creamer According to the Invention

Hot cappuccino beverages were prepared by adding non-dairy foam to about 120 mL of dark coffee, prepared from dehydrated Nescafé Gold instant coffee. The non-dairy foam was obtained by mixing 20 mL of liquid 1D and 20 mL of liquid 2D. The compositions of the liquids are provided below. In this example, the acid used was ascorbic acid. By mixing 20 mL of each liquid 1D and 2D, about 80 to 100 mL of white, sweet and fine non-dairy foam of the invention were obtained. This foam had a density value of about 0.3-0.4 and had good whitening properties.

| | Liquid 1 | Liquid 2 |
|---|---|---|
| Components | D | D |
| Water | 57 | 77 |
| Sodium Caseinate | — | 2 |
| Maltodextrin DE47 | — | 11 |
| Maltodextrin DE 21 | 20 | 7 |
| Sucrose | 20 | — |
| Ascorbic acid | 3 | — |
| Potassium bicarbonate | — | 3 |

### Example 7

### Preparation of Hot Cappuccino Beverage with a Non-dairy Self-foaming Liquid Creamer According to the Invention

Hot cappuccino beverages were prepared by adding non-dairy foam according to the invention to about 120 mL of dark coffee, prepared from dehydrated Nescafé Gold instant coffee. The non-dairy foam was obtained by mixing 20 mL of liquid 1E and 20 mL of liquid 2E. The compositions of the liquids are provided below. In this example, the acids used were ascorbic acid and malic acid. By mixing 20 mL of each liquid 1E and 2E, about 80 to 100 mL of white, sweet and fine non-dairy foam of the invention were obtained. This foam had a density of about 0.3 g/cm³ to 0.4 g/cm³ and had good whitening properties and stability in a cup.

| Components | Liquid 1E | Liquid 2E |
|---|---|---|
| Maltodextrin DE 21 | 20 | 18 |
| Sucrose | 10 | — |
| Skim milk powder | — | 12 |
| KHCO₃ | — | 2.5 |
| Xanthan gum (Kelcol F) | 0.3 | 0.4 |
| Ascorbic acid | 1 | — |
| Malic acid | 1.5 | — |
| TiO₂ | 0.05 | — |
| Vanilla aroma | 0.1 | 0.1 |
| Water | 67.15 | 67 |

The term “about,” as used herein, should generally be understood to refer to both numbers in a range of numerals. Moreover, all numerical ranges herein should be understood to include each whole integer within the range. All percentages herein refer to weight rather than volume, where applicable and unless otherwise noted.

The term “substantially free,” as used herein, means that no more than about 10 weight percent, preferably no more than about 5 weight percent, and more preferably no more than about 1 weight percent of the material is present. In a preferred embodiment, “substantially free” means that no more than about 0.1 weight percent remains. Conversely, “substantially” as it refers to, e.g., dispersing or miscibility, and “substantially all,” typically means that at least 90 weight percent, preferably at least 95 weight percent, and more preferably at least about 99 weight percent, of the material referred to. “Entirely free” typically means that at most only a trace amount of the excluded material is present, and preferably, no detectable amount is present.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

What is claimed is:

1. A self-foaming, liquid creamer comprising:
a first liquid component comprising an edible acid component; and
a second liquid component comprising an edible carbonate salt, bicarbonate salt, or combination thereof;
with the first and second liquids being shelf-stable and being operatively associated so that when the first and second liquids are combined carbon dioxide evolves to assist in providing the foam so that, when the liquid creamer is combined with the beverage, a portion of the creamer melts or disperses in less than about 20 seconds in the beverage to impart a creaming flavor and whitening color to the beverage with the remainder of the creamer forming a foam having a density that is less than that of the beverage so as to reside on top of the beverage as a visible foam layer.

2. The creamer of claim 1, wherein the first and second liquids are each shelf-stable and physically separated during storage.

3. The creamer of claim 1, wherein at least one of the first or second liquids further comprises a protein solution or a polysaccharide solution, or both.

4. The creamer of claim 3, wherein the protein solution comprises a milk powder, whey protein isolate, sweet whey powder, acid whey powder, or calcium caseinate, or a combination thereof, and the polysaccharide solution comprises maltodextrin.

5. The creamer of claim 4, wherein the first and second liquids each have a total solids content of 0.001% to about 50%.

6. The creamer of claim 5, wherein the first liquid comprises a maltodextrin solution with a total solids content of about 1% to 40%.

7. The creamer of claim 4, wherein the second liquid comprises an aqueous skim milk powder solution with a total solid content of about 1% to 60% or comprises a protein solution made basic with about 0.5% to 10% of carbonate or bicarbonate salt, or a combination thereof, with a total solid content of about 1% to 40%.

8. The creamer of claim 1, wherein the acid component comprises one or more organic acids, inorganic acids, or a combination thereof.

9. The creamer of claim 8, where the acid component comprises citric acid, ascorbic acid, tartaric acid, fumaric acid, alginic acid, malic acid, succinic acid, lactic acid, gum arabic, low-methoxy pectin, high-methoxy pectin, glucono-delta-lactone, polygalacturonic acid, monocalcium phosphate monohydrate, monocalcium phosphate, sodium phosphate, potassium phosphate, or a combination thereof.

10. The creamer of claim 9, wherein the acid component comprises ascorbic acid.

11. The creamer of claim 1, wherein the carbonate and bicarbonate salts comprise sodium carbonate, sodium bicarbonate, potassium carbonate, potassium bicarbonate, ammonium bicarbonate, magnesium carbonate, calcium carbonate, or a combination thereof.

12. The creamer of claim 1, in the form of a non-dairy creamer.

13. The creamer of claim 1, in the form of a dairy creamer.

14. The creamer of claim 2, wherein the first and second liquids are disposed in separate compartments of a single package.

15. The creamer of claim 1, wherein at least one of the edible acid component and the edible salt component is encapsulated with a fat-based coating that has a melting point of at least about 25° C. and that is at least substantially free of microparticulated fat.

16. The creamer of claim 15, wherein the coating comprises one or more monoglycerides, diglycerides, triglycerides, acetic acid esters of mono or diglycerides, lactic acid esters of mono or diglycerides, sodium stearoyl lactylates, diacetyl tartaric acid esters of mono or diglycerides, sucrose esters, lecithin, or propylene glycol esters of fatty acids, waxes, fatty alcohols, or a combination thereof.

17. The creamer of claim 1, wherein the beverage comprises tea, coffee, or chocolate, or a combination thereof.

18. A non-pressurized container comprising the creamer of claim 1.

19. A vending machine that includes and dispenses a plurality of products at least one of which comprises the creamer of claim 1.

20. A method for providing a foamed, whitened beverage product which comprises:
combining the first and second liquid components of the creamer of claim 1 to generate a sufficient amount of carbon dioxide to facilitate formation of foam to the creamer; and
combining a sufficient amount of the creamer with beverage components to provide a foamed, whitened beverage having a foam layer thereon and a creaming effect therein.

21. The method of claim 20, wherein the first and second components of the liquid creamer self-foam the creamer before combination with the beverage to provide the foamed beverage.

22. The method of claim 20, wherein the creamer disperses throughout the beverage in less than about 20 seconds.
